(19) United States
(12) Patent Application Publication
(10) Pub. No.: US 2025/0217674 A1
(43) Pub. Date: Jul. 3, 2025

(54) EDGE DEVICE FOR COLLABORATIVE INFERENCE BASED ON SEMANTIC COMMUNICATIONS AND METHOD THEREOF

(71) Applicant: POSTECH RESEARCH AND BUSINESS DEVELOPMENT FOUNDATION, Pohang-si (KR)

(72) Inventors: Yongjune KIM, Pohang-si (KR); Nayoung KWON, Pohang-si (KR); Jiwoong IM, Pohang-si (KR); Jiheon WOO, Pohang-si (KR); Taewoo PARK, Pohang-si (KR)

(73) Assignee: POSTECH RESEARCH AND BUSINESS DEVELOPMENT FOUNDATION, Pohang-si (KR)

(21) Appl. No.: 18/972,644

(22) Filed: Dec. 6, 2024

(30) Foreign Application Priority Data
Dec. 29, 2023 (KR) 10-2023-0196164

(51) Int. Cl. G06N 5/04; H04L 67/10

(52) U.S. Cl. CPC G06N 5/04; H04L 67/10

(57) ABSTRACT

A collaborative inference method based on semantic communications may include acquiring input data by an edge device, performing a first inference on the input data by using a weak machine learning model by the edge device, computing an uncertainty of the inference result by the edge device, extracting semantic information from the input data by the edge device when the uncertainty is greater than or equal to a threshold value, and requesting a second inference by transmitting the semantic information, rather than the entire input data, to a server by the edge device. The edge device may perform the first inference using a first artificial neural network with the weak machine learning model, and the server may perform the second inference using a second artificial neural network with a strong machine learning model. The method can reduce processing latency and bandwidth consumption while enhancing accuracy and computing efficiency.

### CROSS REFERENCE TO RELATED APPLICATION

The present application claims the benefit of and priority to Korean Patent Application No. 10-2023-0196164, filed on Dec. 29, 2023, the entire contents of which are incorporated herein by reference for all purposes.

### BACKGROUND

### Technical Field

The present disclosure relates to a semantic communication technique, and particularly to, for example, without limitation, collaborative inference method based on semantic communications and an edge device.

### Description of the Related Art

6G wireless communication is a key future technology expected to be used in next-generation technologies such as Internet of Things (IoT), autonomous vehicles, and augmented reality. The key features required for 6G communications are extremely low latency and the ability to transfer large amounts of data. Semantic communication is gaining attention as one of the communication methodologies for 6G communication. Semantic communication focuses on transferring semantic information for performing a specific task. In this case, the specific task may include image classification, object detection, image segmentation, and the like.

Recently, the number of edge devices is increasing very rapidly. The performance of edge devices such as smartphones is improving, but applications using models with high complexity such as vision transformers are also increasing. In such an environment, methods such as collaborative inference have been proposed. However, collaborative inference has the limitation of requiring extensive communication between edge devices and servers in order to produce accurate results.

The description of the related art should not be assumed to be prior art merely because it is mentioned in or associated with this section. The description of the related art includes information that describes one or more aspects of the subject technology, and the description in this section does not limit the invention.

### SUMMARY

The inventors of the present disclosure have recognized the problems and needs of the related art, have performed extensive research and experiments, and have developed a new invention that can achieve a reduction in processing latency, bandwidth consumption, communication overhead, and redundant data processing while improving inference accuracy and computing efficiency in the functioning of computers and in the specific technical fields such as image classification, object classification, object segmentation, synthetic data generation, and sentence generation.

In one or more aspects, a collaborative inference method based on semantic communications may include acquiring input data by an edge device, performing an inference on the input data by using a machine learning model by the edge device, computing an uncertainty of a result of the inference by the edge device, extracting semantic information from the input data by the edge device when the uncertainty is greater than or equal to a threshold value, and requesting a second inference by transmitting the semantic information to a server by the edge device, where the semantic information comprises data whose significance for the inference is higher than or equal to a threshold among the input data.

In one or more aspects, a hardware device for performing collaborative inference based on semantic communications may include an interface device for acquiring input data, which is a target to be inferred, a storage device for storing a pre-trained weak machine learning model, a computation device for performing an inference on the input data by using the pre-trained weak machine learning model and for extracting semantic information from the input data when an uncertainty of a result of the inference is greater than or equal to a first threshold value, and a communication device for transmitting the semantic information to a server, where the semantic information comprises data whose significance for the inference is greater than or equal to a threshold among the input data.

In one or more aspects, a hardware device for performing collaborative inference based on semantic communications may include: an artificial neural network; and a communication device, where the artificial neural network includes: a plurality of neuron circuits; and a plurality of synaptic circuits, where: each of the plurality of synaptic circuits is provided between a respective neuron circuit and one or more neuron circuits; each of the plurality of neuron circuits is configured to receive an input and apply a transformation based on a synaptic weight of a respective synaptic circuit; at least some of the plurality of neuron circuits in the artificial neural network are configured to acquire input data; the artificial neural network is configured to perform an inference on the input data and to extract semantic information from the input data when an uncertainty of a result of the inference is greater than or equal to a first threshold value; the communication device is configured to transmit the semantic information to a server having a second artificial neural network, and where the semantic information comprises data whose significance for the inference is greater than or equal to a threshold among the input data.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 is a diagram showing an example of a system for performing collaborative inference.

FIG. 2 is a diagram showing an example of an inference system based on semantic communications.

FIGS. 3A and 3B are diagrams showing a result of selecting a target patch from an input image.

FIG. 4 is a graph showing attention scores for patches of an input image.

FIG. 5 is a graph showing a result of evaluating a relationship between inference accuracy and communication cost.

FIG. 6 is a diagram showing an example of an edge device for performing collaborative inference.

FIGS. 7A and 7B are diagrams showing examples of artificial neural networks.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

First, by way of illustration, the terms used in the following description are explained.

A task may refer to a specific inference using a learning model. For example, a task may include tasks such as image classification, object classification, object segmentation, synthetic data generation, sentence generation, and the like. However, for convenience in the explanation below, the description herein mainly focuses on the task called image classification.

The learning model may be any one of various machine learning models. For example, the learning model may include an artificial neural network model. In an example, the learning model may be a deep learning model. Accordingly, the learning model may be any one of models such as a convolutional neural network (CNN)-based model, a transformer-based model, a vision transformer, and the like.

The transformer is a model structure for natural language processing. The transformer may include an encoder, multi-headed attentions, and a feed-forward network (FFN). The transformer may use an attention mechanism.

A vision transformer may be a transformer-based model for image processing. A vision transformer is an image processing model that operates in a way an image is reconstructed by dividing the input image into small patches and computing the attention score for each patch.

Hereinafter, for convenience in the explanation, the description mainly focuses on the vision transformer that performs image classification. However, the technology described herein may be applied to various deep learning models and various inference tasks.

The technology described herein may be applied to collaborative inference using edge devices and servers. The edge device may transmit data for inference to the server and receive an inference result from the server. In some examples, the technology described herein may provide a communication method that transmits only semantic information important for processing tasks according to the attention mechanism.

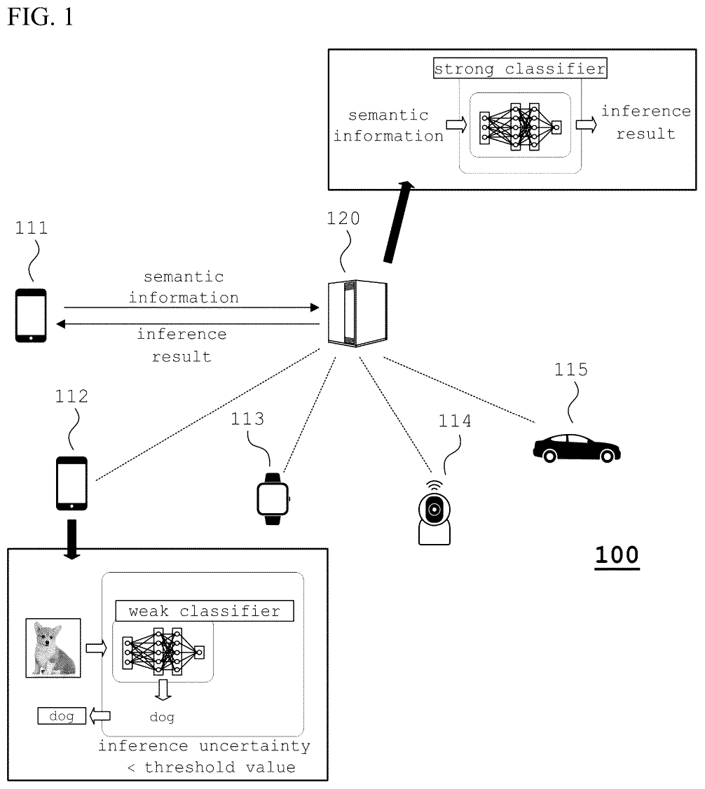

FIG. 1 is a diagram showing an example of a system 100 for performing collaborative inference. The system 100 of FIG. 1 may include edge devices 111, 112, 113, 114, 115 and a server 120.

The edge devices 111, 112, 113, 114, 115 may efficiently perform a task through semantic communications with the server 120. The edge device may be any one of devices such as a mobile device, a smartphone, a wearable device, an IoT device, an automobile, a robot, and the like. The edge devices 111, 112, 113, 114, 115 may be lower-specification devices compared to the server 120. For example, an edge device may have less processing power, memory, storage, or other resources than a more advanced or higher-end device such as a server. An edge device may include a terminal device. A server may be a cloud server, a server computer, or a computer.

The server 120 may be a device with extensive computing power. The server 120 may be capable of fast computational processing of relatively complex (or heavy) models such as vision transformers, generative models, and the like.

The edge devices 111, 112, 113, 114, 115 may perform image classification by using a pre-trained deep learning model.

The edge devices 111, 112, 113, 114, 115 may classify the input image by using a weak classifier. The weak classifier may be any one of various types of deep learning models. The weak classifier may perform classification on the input image. The weak classifier may be a pre-trained model.

Meanwhile, the server 120 may classify the input image by using a strong classifier. The strong classifier may be a pre-trained learned model.

The weak classifier may correspond to a model having a simple deep learning structure and a small number of parameters. For example, the weak classifier may be a model where the number of identical blocks (layers) is less than a certain (or predetermined) first threshold value. In this case, the strong classifier may be a model where the number of identical blocks is greater than or equal to the first threshold value. Alternatively, the strong classifier may be a model where the number of identical blocks is greater than or equal to a second threshold value (where the first threshold value<the second threshold value).

Alternatively, the weak classifier may be a model where the number of parameters of the model is less than a certain third threshold value. In this case, the strong classifier may be a model where the number of parameters of the model is greater than or equal to the third threshold value. Alternatively, the strong classifier may be a model where the number of parameters of the model is greater than or equal to a fourth threshold value (where the third threshold value<the fourth threshold value).

For example, the edge device 112 may acquire a certain image as an input. The edge device 112 may classify the input image by using the weak classifier. The classification result of the weak classifier may be “dog”. The edge device 112 may compute an inference uncertainty of the weak classifier and determine that the inference result is correct when the inference uncertainty is less than a certain fifth threshold value. In this case, the edge device 112 may utilize the final classification result as it is without communicating with the server 120.

Meanwhile, the edge device 111 may acquire a certain image as an input. The edge device 111 may classify the input image by using the weak classifier. The edge device 111 may compute the inference uncertainty of the weak classifier. When the inference uncertainty is greater than or equal to the fifth threshold value, the edge device 111 may extract semantic information important for classification from the input image. Semantic information may be specific information important for task processing. The semantic information may include a part of the entire input image or a part of data extracted from the input image. The edge device 111 may transmit the semantic information to the server 120. The server 120 may perform a certain inference by inputting the received semantic information to the strong classifier. The server 120 may transmit the inference result to the edge device 111. The edge device 111 may provide information based on the inference result.

Hereinafter, the vision transformer will be described as an example.

The vision transformer may have the backbone structure identical to the transformer, which is a natural language processing model. The vision transformer may segment the input image into small patches, and process each patch as a token of the transformer. The vision transformer may generate a class token for each patch through an embedding block, and perform image classification by inputting the class token into FFN.

Models of various structures have been developed for vision transformers. For example, DeiT (H. Touvron et al., “Training data-efficient image transformers & distillation through attention,” in Proc. Int. Conf. Mach. Learn. (ICML), July 2021, pp. 10 347-10 357.) showed high performance even with relatively small datasets. DeiT can be classified according to the number of parameters of a model, as shown in Table 1 below. The classification accuracy may be the result verified by the model developer using the ImageNet dataset.

TABLE

| | Number of parameters | |
|---|---|---|
| Model | (million, M) | Classification accuracy (%) |
| DeiT-Tiny | 5 | 72.2 |
| DeiT-Small | 22 | 79.8 |
| DeiT-Base | 86 | 81.8 |

For example, DeiT-Tiny may correspond to the weak classifier with 5 million (M) parameters. DeiT-Base may correspond to the strong classifier with 86 M parameters.

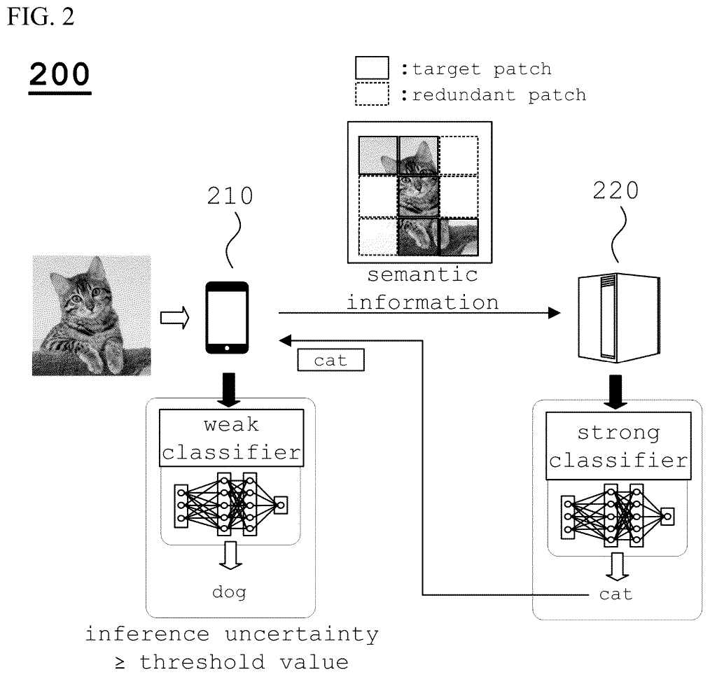

FIG. 2 is a diagram showing an example of an inference system 200 based on semantic communications. In FIG. 2, the classifier may be a model that extracts features in units of patches like vision transformers and performs a certain inference.

The edge device 210 may be any one of various types of devices such as smart devices, IoT devices, sensors, automobiles, robots, and the like.

The edge device 210 may perform inference on an image by using its own classifier. The edge device 210 may request inference from the server 220 according to the uncertainty of the inference result and receive the inference result from the server 220.

The edge device 210 may use the weak classifier (a first classifier). For example, the weak classifier may be a model such as DeiT-Tiny.

The edge device 210 may acquire a certain image (e.g., a cat image).

The edge device 210 may classify the input image by using the weak classifier. It may be assumed that the classification result is “dog”. In this case, the edge device 210 may compute its own inference uncertainty. It may be assumed that the inference uncertainty is greater than or equal to a certain threshold value. In this case, the edge device 210 may not be able to trust its inference result.

The edge device 210 may extract semantic information for the classification task. The edge device 210 may segment the input image into a plurality of patches and select patches that have an important influence on inference as semantic information. Hereinafter, the patch selected as semantic information among the plurality of patches may be referred to as a target patch. The process of selecting target patches will be described later. The edge device 210 may select a plurality of target patches among the entire patches. Alternatively, the edge device 210 may select a plurality of redundant patches among the entire patches. A redundant patch is an unnecessary patch for the inference.

The edge device 210 may transmit the selected target patches to the server 220.

The server 220 may classify the input image by using the strong classifier (a second classifier). For example, the strong classifier may be a model such as DeiT-Base. The server 220 may perform inference by inputting target patch(s), which is or includes semantic information, into the strong classifier. The classification result of the strong classifier may be “cat”. The server 220 may transmit the classification result to the edge device 210.

The edge device 210 may perform the task by transmitting only the semantic information to the server 220. In this way, semantic communications may reduce the amount of communication and the time to perform the task.

The weak classifier of the edge device may be used to compute information for determining semantic information. The attention-based classifier may compute an attention score for each of the plurality of patches (tokens). The edge device may determine the target patch important for inference among all patches on the basis of the attention score of the patch (token).

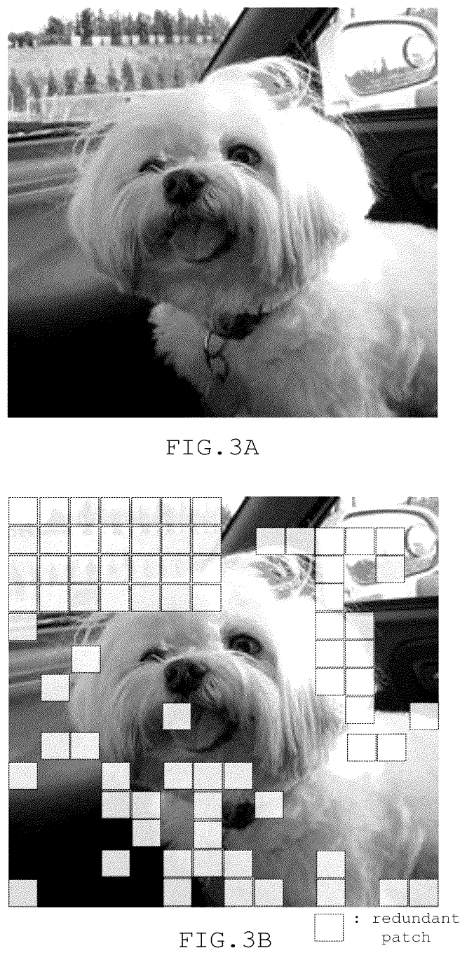

FIGS. 3A and 3B illustrate a result of selecting target patches from an input image. FIGS. 3A and 3B illustrate an example of classifying an input image by using DeiT-Tiny (the weak classifier) and of selecting target patch(s).

FIG. 3A may be the original image. The original image may be a Maltese dog. The weak classifier (DeiT-Tiny) may classify the original image as “Lhasa apso”. The strong classifier (DeiT-Base) may classify the original image as “Maltese dog”. That is, the weak classifier has made a wrong inference.

FIG. 3B may be a result of the weak classifier selecting the target patch on the basis of the attention score. The weak classifier may compute the attention score for each patch in the inference process. The edge device may determine the target patch on the basis of the attention score of the patch. For example, the edge device may select a patch whose attention score is greater than or equal to a certain threshold value as a target patch. In addition, the edge device may select a patch whose attention score is less than the threshold value as an unnecessary redundant patch. When the target patch(s) are selected, the edge device may select the remaining patch(es) as redundant patches. FIG. 3B illustrates redundant patches that are not transmitted to the server in FIG. 3A. Referring to FIG. 3B, it may be seen that most of the redundant patches are areas that have little contribution to object classification.

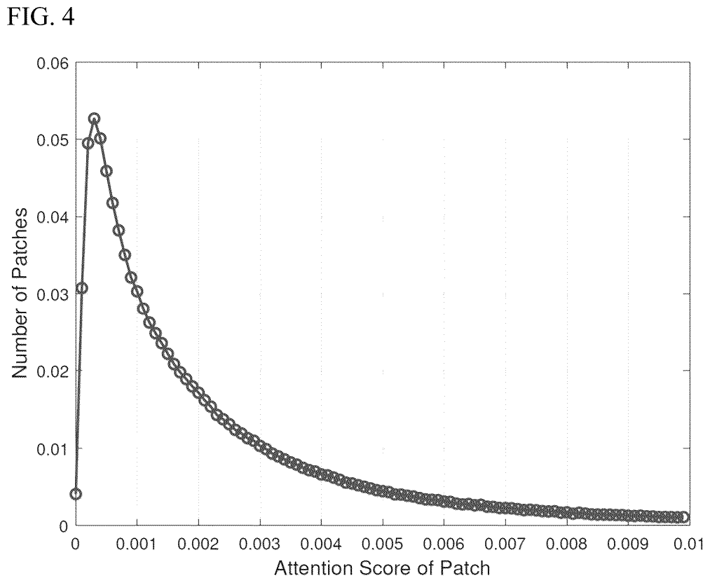

FIG. 4 depicts a graph with a result showing attention scores for patches of the input image. FIG. 4 shows the result of computing attention scores for patches of the image of FIGS. 3A and 3B. FIG. 4 shows the result of DeiT-Tiny computing attention scores of class tokens for image patches. Referring to FIG. 4, patches whose attention scores are less than 0.001 may account for approximately 38% of all patches. Patches with high attention scores may be important for image classification. Referring to FIG. 4, it may be seen that the number of patches important for image classification is significantly small compared to the total number of all patches.

A process of the edge device selecting the target patch from the input image by using the weak classifier will be described. The edge device may select the target patch(es) by using one of various techniques on the basis of the attention score. As an example, three target patch selection criteria are described.

### (1) Select a Fixed Number of Patches (a First Technique)

The edge device may select a preset number of k patches from the total number of patches. The edge device may compute the attention score for each of the patches of the image. The edge device may remove the lower N−k patches with a low attention score from the total N patches and select the upper k patches with a high attention score. Each of N and k may be a positive integer, where k is less than or equal to N.

### (2) Select Patches on the Basis of a Threshold Value (a Second Technique)

The edge device may compute the attention score for each of the patches of the image. The edge device may select patches whose attention scores are higher than a preset threshold value δ as target patches among the patches.

### (3) Select Patches on the Basis of the Sum of Attention Scores (a Third Technique)

The edge device may compute the attention score for each of the patches of the image. The edge device may select upper patches with high attention scores under the condition that the sum of attention scores does not exceed a preset threshold value δₛᵤₘ. That is, the edge device may select the maximum number of patches in a descending order under the condition that the sum of attention scores does not exceed the threshold value δₛᵤₘ.

In an example, this technique may include the following process: (i) sort the patches by their attention scores in descending order; (ii) initialize a running sum as 0 and a count of selected patches as 0; and (iii) for each patch in the sorted listed: if adding the current patch's attention score to the running sum keeps it below the threshold value, add the current patch's score to the sum and increment the count of selected patches; otherwise, stop this process. The selected patches are those whose attention scores were added without exceeding the threshold value. This method ensures selecting the maximum number of patches while keeping the total sum of attention scores under the threshold value.

A process of the edge device computing the attention score for the patch will be described. The edge device may compute the attention score by using any one of various techniques.

The edge device may extract the attention score for the class token from the last multi-head self-attention (MSA) layer of the vision transformer. The edge device may compute a final attention score by averaging the attention scores of the MSA layers. The attention score may represent the ratio of the class token structure in the last layer. That is, the attention score may represent how much the corresponding patch contributes to the classification task. The edge device may select the patch having a high attention score of the class token as the target patch important for classification.

Alternatively, the edge device may compute a final attention score for any one patch by using the attention scores computed from a plurality of layers of the vision transformer. For example, the edge device may compute the attention score by using an attention rollout.

The edge device may compute the uncertainty for the inference results using the weak classifier. As described above, when the inference uncertainty of the weak classifier is greater than or equal to a certain threshold, the edge device may request collaborative inference by transmitting semantic information to the server. Conversely, when the inference uncertainty of the weak classifier is less than a certain threshold, the edge device may use only the inference result of the weak classifier. The edge device may request inference from the server when the inference uncertainty is greater than or equal to the threshold value as shown in Equation 1 below.

$$g ( {x}_{i} ) \geq η \qquad [ Equation 1 ]$$

g: [symbol] ^{L}→ [symbol] is a function of an uncertainty operation, and L is the number of output classes. xᵢ is the input image, and n is the threshold for the uncertainty.

The edge device may compute the uncertainty of inference by using one of several criteria including Shannon entropy or minimum entropy.

Shannon entropy may be a general indicator of the uncertainty of a probability distribution (see T. M. Cover and J. A. Thomas, Elements of Information Theory, 2nd ed. Hoboken, NJ, USA: Wiley-Interscience, 2006, etc.). Shannon entropy may be expressed as Equation 2 below.

$${g}_{s} ( {x}_{i} ) = - {\sum }_{y ∈ Y} {p}_{θ} ( y \vert {x}_{i} ) {log}_{2} {p}_{θ} ( y \vert {x}_{i} ) \qquad [ Equation 2 ]$$

Y is the set of entire classes possible for an image xᵢ. y is a specific class classified by the model θ. High Shannon entropy may represent high uncertainty. For example, when the Shannon entropy of the inference for the input image is greater than ηₛ, the edge device may select target patches from the input image and transmit the target patches to the server.

The minimum entropy may be defined as the maximum probability of a probability distribution as shown in Equation 3 below.

$${g}_{m} ( {x}_{i} ) = - {log}_{2} {max}_{y ∈ Y} {p}_{θ} ( y \vert {x}_{i} ) \qquad [ Equation 3 ]$$

When the maximum probability is small, the minimum entropy may be high. When the minimum entropy of the inference for the input image is greater than nm, the edge device may select target patches from the input image and transmit the target patches to the server.

Meanwhile, the threshold value may be experimentally determined depending on the type of input data, the type of classifier, and the like.

Algoritum 1 below shows the collaborative inference process described above.

Algorithm 1 Proposed Algorithm

| Input: Images x = {x₁,x₂,...,xₙ}. | | |
|---|---|---|
| Output: Classification results y = {y₁,y₂,...,yₙ}. | | |
| 1: | for i = 1 : n do | |
| 2: | ŷᵢ = f_{c}(xᵢ) | [symbol] Client classifies xᵢ |
| 3: | Client computes uncertainty g(xᵢ) | |
| 4: | if g(xᵢ) ≥ η then | |
| 5: | zᵢ = patch-selection(xᵢ) | |
| 6: | Client transmits zᵢ | |
| 7: | ŷᵢ = fₛ(zᵢ) | [symbol] Server classifies zᵢ |

| | |
|---|---|
| 8: | Client receives ŷᵢ |
| 9: | end if |
| 10: | end for |

The input data for Algorithm 1 may be a set of input images x={x₁, x₂, . . . , xₙ}. The output of Algorithm 1 may be the inference result y={y₁, y₂, . . . , yₙ} for each image. The edge device may perform collaborative inference on each of the total n input images (lines 1 to 10). The edge device may derive the inference result ŷᵢ for xᵢ by using the weak classifier f_{c} (line 2). The edge device may compute the uncertainty for the inference result of xᵢ (line 3). When the uncertainty of the inference for xᵢ is greater than or equal to a threshold value, the edge device may select a target patch zᵢ among patches of the input image (line 5). The edge device may transmit the target patch zᵢ to the server (line 6). The server may derive the inference result ŷᵢ for zᵢ by using the strong classifier fₛ (line 7). The server may transmit the inference result ŷᵢ to the edge device (line 8).

A method may be used to evaluate the performance of the collaborative inference based on semantic communications described herein. The method may prepare the validation data by cropping a center area of 224×224 pixels from the ImageNet-1k dataset. The method may use DeiT-Tiny as the weak classifier of edge devices and use DeiT-Base as the strong classifier of the server. The method may use the score of the last layer of the vision transformer as the attention score of the patch. The method may select the target patch on the basis of the sum of attention scores (the third technique described above). In addition, the method may utilize the minimum entropy for measuring the uncertainty.

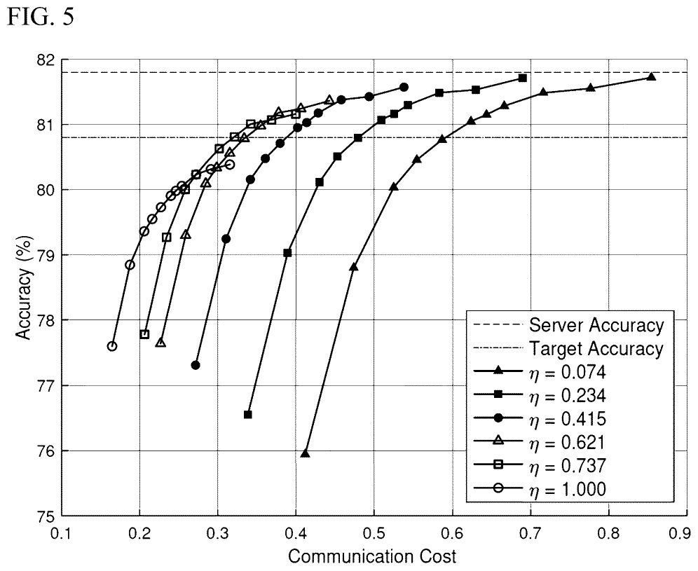

FIG. 5 depicts a graph with the results of evaluating the relationship between inference accuracy and communication cost. In this case, the communication cost is defined as the ratio of patches to be transmitted to the server among all patches of the image. The server accuracy may be 81.8%, which is the accuracy of the strong classifier, DeiT-Base. The aimed target accuracy may be set to 80.8%, which is 1% lower than the accuracy of the strong classifier. The n may represent a threshold value for the minimum entropy. The n may be set to various values from 1 to 0.074. Referring to FIG. 5, it may be seen that the collaborative inference based on semantic communications according to one or more aspects of the subject technology achieves the aimed accuracy while reducing the communication cost by approximately 68%.

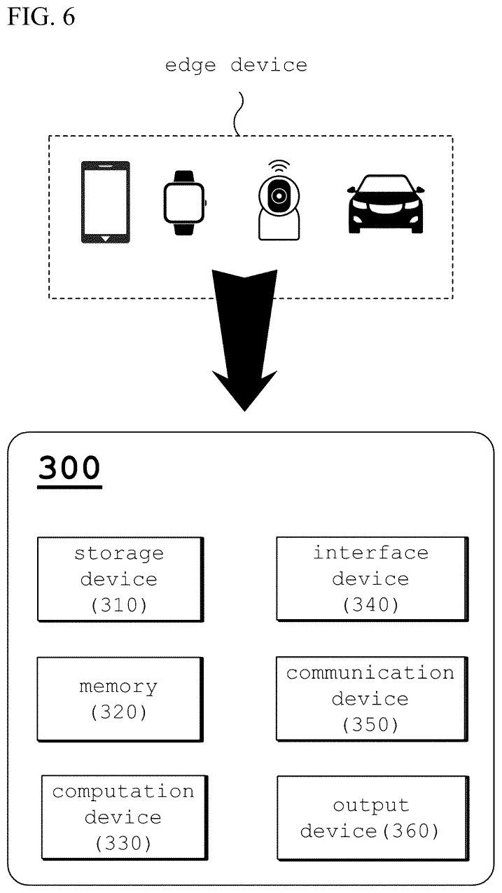

FIG. 6 is an example of an edge device 300 performing collaborative inference. The edge device 300 may correspond to the edge devices 111-115, 210 of FIGS. 1 and 2. The edge device 300 may be physically implemented in various forms. For example, the edge device 300 may take the form of a smart device, a vehicle, a sensor, an IoT device, a wearable device, a robot, a chipset dedicated to data processing, and the like.

The edge device 300 may include a storage device 310, a memory 320, a computation device 330, an interface device 340, a communication device 350, and an output device 360.

The storage device 310 may store an inputted image.

The storage device 310 may store the deep learning model for certain inference. The deep learning model may be any one of models that perform object identification of an image, image classification, image-based certain information extraction, and the like.

The storage device 310 may store the weak classifier described herein. The weak classifier may be a pre-trained model.

The storage device 310 may store the image inference result.

The memory 320 may store data and information generated in the process of inferring the input image, computing the uncertainty of the inference, selecting significant patches, and the like.

The interface device 340 may be a device that inputs a certain command and data from the outside.

The interface device 340 may input an image, the target to be inferred.

The interface device 340 may input the weak classifier from another object (or device).

The interface device 340 may transmit patches selected from the input images to another object (or device).

The interface device 340 may be configured to transmit data received through the communication device 350 to one or more objects (or devices) within the edge device 300 (e.g., 310, 320, 330, 360).

The communication device 350 may refer to a configuration for receiving and transmitting certain information through a wired or wireless network.

The communication device 350 may receive an image, which is the target to be inferred.

The communication device 350 may receive the weak classifier from another object (or device).

The communication device 350 may transmit the patches selected from the input image to an object (or device) such as a server.

The communication device 350 may receive the inference result of the input image from the server.

The computation device 330 may perform inference on the input image by using the weak classifier.

The computation device 330 may compute the uncertainty of the inference result for the input image. The uncertainty may be, or may be based on, any one of Shannon entropy or minimum entropy.

When the uncertainty of the inference result exceeds a certain threshold value th₁, the computation device 330 may select significant patches from the input image.

The computation device 330 may compute an attention score for each patch of the input image. For example, the computation device 330 may compute the attention score for the patches by computing the attention score for the class token in the last layer of the vision transformer. Alternatively, the computation device 330 may compute the final attention score by using attention scores extracted from multiple layers (blocks) of the vision transformer. For example, as described above, the computation device 330 may compute the final attention score by using an average value or recursive product for the attention score computed in multiple layers for a specific patch.

The computation device 330 may select the target patch(es) from patches on the basis of the attention scores. The computation device 330 may select a certain number (k) of upper patches as significant patches on the basis of the attention scores. The computation device 330 may select patches, whose attention scores are higher than or equal to a certain threshold value th₂ among all patches, as significant patches. The computation device 330 may select as many upper patches having high attention scores as possible within a range in which the sum of the attention scores does not exceed the threshold value th₃.

The computation device 330 may be a device which processes data and performs certain operations. The computation device 330 may be a device, such as a processor, an application processor (AP), an access point, an integrated circuit chip, or an application-specific integrated circuit (ASIC), where the device may include an embedded program that processes data and performs certain operations. In some examples, the device includes multiple devices.

The output device 360 may be a device for outputting certain information. The output device 360 may output the interface and the inference result required for the inference process.

The description above may focus on the classification task for the input data image. The target of semantic-based collaborative inference may be any one of an object detection task for the input image, a caption generation task for the input image, and a task of generating another image on the basis of the input image.

Furthermore, semantic-based collaborative inference may be applied to tasks for various data. For example, semantic-based collaborative inference may include object detection from an image, annotation generation of an image, object information extraction, and the like.

The storage device 310 may store input data.

The storage device 310 may store the deep learning model that performs certain inference or operations. For example, (i) the deep learning model may be an object segmentation model, a transformer-based caption generation model, an adversarial generation model for image generation, and the like. (ii) The deep learning model may be a transformer-based model that generates input text to voice, image, or response sentences. Alternatively, (iii) the deep learning model may be a model that generates an image by receiving a text prompt. However, the storage device 310 may store the weak deep learning model. In this case, the server may store the strong deep learning model. The weak deep learning model may be a model trained with significantly fewer parameters than the strong deep learning model.

The storage device 310 may store the deep learning model inference result or data generated by the deep learning model.

The memory 320 may store data and information generated in the course of input data processing, deep learning model inference or operation.

The interface device 340 may be a device that inputs a certain command and data from the outside.

The interface device 340 may input the input data. The input data may be an image, text, or voice.

The interface device 340 may input the weak deep learning model from another object (or device).

The interface device 340 may transmit semantic information selected from the input data to another object (or device). The semantic information may be target patches important for inference among patches of the input data.

The interface device 340 may be configured to transmit data received through the communication device 350 to the inside.

The communication device 350 may refer to a configuration for receiving and transmitting certain information through a wired or wireless network.

The communication device 350 may receive the input data.

The communication device 350 may receive the weak deep learning model from another object (or device).

The communication device 350 may transmit semantic information selected from the input data to an object (or device) such as a server. The semantic information may be target patches important for inference among patches of the input data.

The communication device 350 may receive the inference result of the strong deep learning model or output data of the strong deep learning model from the server.

The computation device 330 may perform inference on input data by using the weak deep learning model. Alternatively, the computation device 330 may compute certain data by inputting the input data into the weak deep learning model. In this case, the data outputted by the deep learning model may be any one of text, voice, an image, and an object (mask) in the image.

The computation device 330 may compute the uncertainty of the inference result for the input data. The uncertainty may be, or may be based on, any one of Shannon entropy or a minimum entropy.

When the uncertainty of the inference result exceeds the threshold value th₁, the computation device 330 may extract semantic information from the input data.

The computation device 330 may segment the input data into a plurality of patches, input the plurality of patches into the deep learning model, and compute the attention score for each patch. The attention score may be an attention score of the last layer that performs the attention operation in the deep learning model. Alternatively, the attention score may be the result of mathematically calculating (average, recursive multiplication, etc.) attention scores computed from a plurality of layers of the deep learning model.

The computation device 330 may select the target patch(es) from patches on the basis of the attention score(s). The computation device 330 may select a certain number (k) of upper patches as significant patches on the basis of the attention scores. The computation device 330 may select the patch, whose attention score is higher than a certain threshold value th₂ among all patches, as a significant patch. The computation device 330 may select as many upper patches having high attention scores as possible within a range where the sum of the attention scores does not exceed the threshold value th₃.

The computation device 330 may be a device which processes data and performs certain operations. The computation device 330 may be a processor, an AP or a chip.

The output device 360 may be a device that outputs certain information. The output device 360 may output the interface required for the inference process and the inference result.

Furthermore, in some examples, the semantic information may not be in the form of a patch extracted from the input data. The semantic information may be a specific area or multiple areas classified as a result of performing an attention operation on the entire image.

In addition, the semantic communication method and the collaborative inference method based on semantic communications as described herein may be implemented as a program (or application) including an executable algorithm that may be executed on a computer. The program may be stored and provided in a transitory or non-transitory computer-readable medium.

The non-transitory readable medium (e.g., the storage device 310) may refer to a medium that stores data semi-permanently and is readable by a device, rather than a medium that stores data for a short period of time, such as a register, a cache, and a memory. Specifically, the various applications or programs described above may be stored and provided in a non-transitory readable medium, such as a CD, DVD, hard disk, Blu-ray disk, USB, memory card, ROM (read-only memory), PROM (programmable read-only memory), EPROM (Erasable PROM, EPROM), EEPROM (Electrically EPROM), or flash memory.

Transitory readable media may refer to various types of RAM, such as Static RAM (SRAM), Dynamic RAM (DRAM), Synchronous DRAM (SDRAM), Double Data Rate SDRAM (DDR SDRAM), Enhanced SDRAM (ESDRAM), Synclink DRAM (SLDRAM), and Direct Rambus RAM (DRRAM).

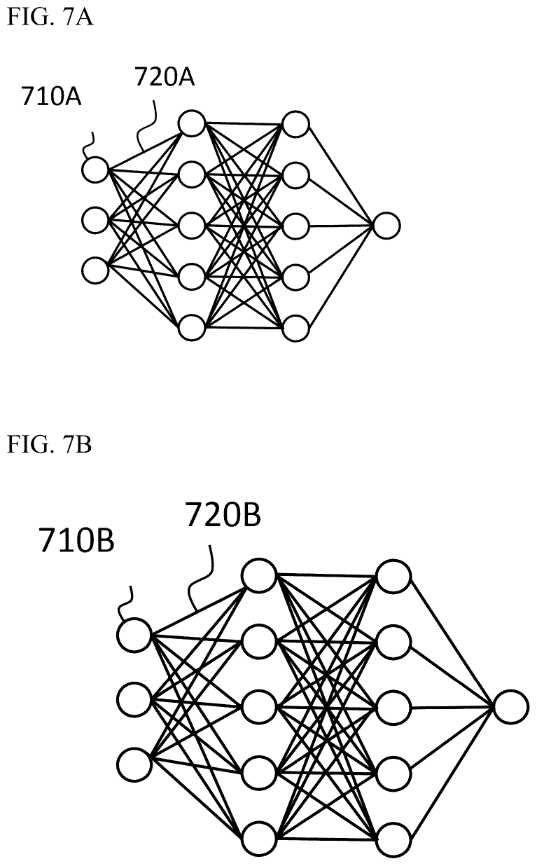

FIGS. 7A and 7B are diagrams showing examples of artificial neural networks. FIG. 7A illustrates an example artificial neural network that may be embodied in an edge device. The artificial neural network of FIG. 7A may include neuron circuits (or neurons) 710A and synaptic circuits (or connections or edges) 720A. FIG. 7B illustrates an example artificial neural network that may be embodied in a server. The artificial neural network of FIG. 7B may include neuron circuits (or neurons) 710B and synaptic circuits (or connections or edges) 720B.

Various examples and aspects of the present disclosure are described below.

This invention represents a significant technological improvement by enhancing the efficiency and accuracy of collaborative inference within edge computing environments. Traditionally, collaborative inference has faced challenges due to the extensive communication required between edge devices and servers to achieve high-accuracy results.

The method and apparatus developed by the inventors overcome these limitations by employing novel semantic communication techniques specifically tailored for collaborative inference and an unconventional combination of collaborative inference and semantic communication. This novel approach enables an edge device and a server to collaboratively infer information with reduced communication overhead, thus achieving both higher computing efficiency and higher inference accuracy.

This invention advances the functioning of computers by reducing processing latency and bandwidth consumption, thereby providing improvements over conventional collaborative inference systems. The inventors' novel semantic communication technique streamlines the data exchanges between edge devices and servers, directly improving system performance in real-time applications. Furthermore, the invention brings forth advancements and improvements in specific technical fields such as image classification, object classification, object segmentation, synthetic data generation, and sentence generation.

By enabling efficient collaborative inference across these domains, the invention offers a solution that significantly enhances the performance of edge-based artificial neural network (ANN) systems, thereby improving the functional operation of computing devices and enhancing the quality and reliability of their outputs.

In one or more aspects of the present disclosure, the novel semantic communication-based collaborative inference method and apparatus also result in a structural and operational improvement, specifically through its ability to distill and transmit only the necessary semantic information required for accurate inference. As a result, this reduces redundant data processing and allows for rapid synthesis of inferences. By advancing the technical processes underlying collaborative inference, one or more aspects of the invention not only address bandwidth and latency constraints but also enable an entirely new operational paradigm for ANN-driven edge computing applications. The enhanced performance metrics further emphasize the transformative nature of the invention, marking a substantive advancement in the underlying technological fields and contributing to the overall improvement of collaborative inference frameworks.

Various examples and aspects of the present disclosure are described further below.

In one or more aspects of the present disclosure, a collaborative inference method based on semantic communications may be carried out by a hardware apparatus in collaboration with another hardware apparatus. In one or more examples, the hardware apparatus may be an edge device (e.g., 111, 112, 113, 114, 115, 200, 300), and the another hardware apparatus may be a server (e.g., 120, 220). A hardware apparatus may be referred to as a hardware device. In one or more examples, a hardware apparatus includes hardware components (e.g., hardware electronic components such as integrated circuits). A hardware apparatus may also include software in addition to hardware components.

In one or more aspects, an edge device may acquire input data (e.g., image, text, voice). The edge device may then perform an inference on the input data by using a machine learning model or an artificial neural network.

In one or more aspects, the edge device extracts semantic information from the input data. The edge device may perform the semantic information extraction when an uncertainty of a result of the inference is greater than or equal to a first threshold value. The semantic information includes data whose significance for the inference is higher than or equal to a threshold among the input data. The edge device may then transmit the semantic information to a server. In one or more aspects of this process, the edge device uses a weak machine learning model while the server uses a strong machine learning model, and the size of the semantic information is less than the size of the input data. Thus, while the edge device may perform the inference on the input data using the weak machine learning model, the server may perform a second inference on the semantic information using the strong machine learning model. Therefore, unlike a conventional approach, the foregoing novel technique can reduce processing latency, bandwidth consumption, communication overhead, and redundant data processing while achieving higher inference accuracy and computational efficiency in the functioning of computers and in the specific technical fields such as image classification, object classification, object segmentation, synthetic data generation, and sentence generation.

For example, performing an inference by the edge device (e.g., a lower-specification device compared to the server) and then performing a second inference by the server can improve, among others, inference accuracy and computing efficiency in the functioning of computers and in the technological fields described herein. Further, transmitting to the server only the semantic information (rather than the entire input data) can reduce, among others, processing latency, bandwidth consumption, communication overhead, and redundant data processing in the functioning of computers and in the technological fields described herein. Moreover, extracting the semantic information when an uncertainty of a result of the inference is greater than or equal to a first threshold value, and restricting the semantic information to include data whose significance for the inference is higher than or equal to a threshold among the input data, can improve inference accuracy while reducing processing latency, bandwidth consumption, communication overhead, and redundant data processing in the functioning of computers and in the technological fields described herein.

Further, in an aspect of the present disclosure, in order to determine the semantic information to be transmitted to the server, the edge device may segment the input data into segments (or patches or tokens), determine attention scores of the segments (e.g., by using attention values computed in the process of performing the inference using the machine learning model), and extract the semantic information comprising data whose attention score is greater than or equal to a second threshold value among the input data. The foregoing process can improve inference accuracy while reducing processing latency, bandwidth consumption, communication overhead, and redundant data processing.

Further, in an aspect of the present disclosure, in order to determine the semantic information to be transmitted to the server, the edge device may compute the uncertainty based on an entropy of the result of the inference, and extract the semantic information based on the uncertainty. This process can also improve inference accuracy while reducing processing latency, bandwidth consumption, communication overhead, and redundant data processing.

Further, in an aspect of the present disclosure, in order to determine the semantic information to be transmitted to the server, the edge device may use the machine learning model that is a transformer-based model, and the semantic information may comprise at least one patch selected from a plurality of patches based on attention scores of a plurality of tokens segmented from the input data. This process can also improve inference accuracy while reducing processing latency, bandwidth consumption, communication overhead, and redundant data processing.

Further, in an aspect of the present disclosure, when the input data comprises an image, in order to determine the semantic information to be transmitted to the server, the edge device may use the machine learning model that is a vision transformer model, and the semantic information may comprise at least one patch selected from a plurality of patches based on attention scores of the plurality of patches segmented from the input data which is an image. This process can also improve inference accuracy while reducing processing latency, bandwidth consumption, communication overhead, and redundant data processing.

Further, in an aspect of the present disclosure, in order to determine the semantic information to be transmitted to the server, the edge device may extract the semantic information that comprises: a certain number of upper patches among the plurality of patches based on the attention scores of the plurality of patches; patches whose attention scores are higher than or equal to a certain threshold value among the plurality of patches; or patches selected from the plurality of patches based on a descending order of the attention scores of the plurality of patches, where the selected patches correspond to a maximum number of patches, and where a sum of the attention scores of the selected patches are less than a certain threshold value. This process can also improve inference accuracy while reducing processing latency, bandwidth consumption, communication overhead, and redundant data processing.

In an aspect of the present disclosure, the edge device may receive a result of the second inference that is performed by the server based on the semantic information transmitted by the edge device, and the edge device may use the result of the second inference to classify or identify the input data. The result of the second inference from the server may be more accurate than the result of the inference performed by the edge device. This process can thus improve, among others, inference accuracy.

Unlike a conventional approach, technical aspects of the present disclosure can thus produce advancements and improvements in the functioning of computers and the technical fields such as image classification, object classification, object segmentation, synthetic data generation, and sentence generation by: performing an inference on input data using a machine learning model; extracting semantic information from the input data; and transmitting the semantic information to a server, where the semantic information includes data whose significance for the inference is greater than or equal to a threshold among the input data.

Various examples and aspects of the present disclosure are described further below.

In one or more aspects, a first hardware apparatus (e.g., an edge device) may include a first artificial neural network (ANN) (e.g., an ANN having a weak machine learning model), and a second hardware apparatus (e.g., a server) may include a second artificial neural network (e.g., an ANN having a strong machine learning model). In some examples, each of the first and second artificial neural networks may be embodied in one or more processors and/or integrated circuits with embedded weights, parameters and programs. In an example, the first artificial neural network may be embodied in the computation device 330 and/or the storage device 310. In an example, each of the first and second artificial neural networks may include a plurality of neuron circuits (or neurons) (e.g., 710A or 710B, respectively). Each neuron circuit may be a processing circuit for receiving an input, applying a transformation, and providing an output. An output may be provided to one or more neuron circuits (e.g., in the next layer) or to a final output node (in the case of the final output). Neuron circuits may be organized into layers, and each layer may perform a distinct operation. Each of the first and second artificial neural networks may include a plurality of synaptic circuits (or connections or edges) (e.g., 720A or 720B, respectively) between neuron circuits. Each synaptic circuit may include a synaptic weight. Each neuron circuit may be connected to at least one other neuron circuit using a synaptic circuit. In other words, a synaptic circuit may be provided between a respective neuron circuit and one or more neuron circuits. Each neuron circuit may apply a transformation based on a synaptic weight of a respective synaptic circuit. Synaptic weights may be learned during a machine learning process.

In an example, each of the first and second artificial neural networks may include at least thousands of neuron circuits. In an example, each of the first and second artificial neural networks may include at least a million neuron circuits. In an example, each of the first and second artificial neural networks may include at least ten million neuron circuits. In one or more aspects, the total number of neuron circuits of the first artificial neural network is less than, or significantly less than (in an advantageous example), the total number of neuron circuits of the second artificial neural network. In an example, an edge device of the present disclosure may perform the following in real time: performing an inference on input data; computing an uncertainty of a result of the inference; extracting semantic information from the input data when an uncertainty of a result of the inference is greater than or equal to a first threshold value; and requesting a second inference by transmitting the semantic information to a server, where the first three tasks are performed using a machine learning model or an artificial neural network. In an example, the foregoing may be performed in a few milliseconds. In some examples, the foregoing may be performed in less than a second or less than a few seconds. In some examples, an edge device may segment an input data into more than a thousand segments (or patches) or more than a million segments (or patches), where a neuron circuit (e.g., a neuron circuit at an input layer) may receive a segment (or patch). In an example, the neuron circuits and the synaptic circuits operate or include discrete digital data in digital domain.

In a collaborative inference method based on semantic communications, an edge device having the first artificial neural network may obtain input data (e.g., image, text, voice). In an example, each of the neuron circuits of the first artificial neural network receives an input and applies a transformation based on a synaptic weight of a respective synaptic circuit. In an example, some neuron circuits of the first artificial neural network may receive the input data.

In order to reduce processing latency, bandwidth consumption, communication overhead, and redundant data processing while achieving higher inference accuracy and computing efficiency in the functioning of computers and in the specific technical fields described herein, the first artificial neural network of the edge device (e.g., at least some of the neuron circuits and at least some of the synaptic circuits of the first artificial neural network) may perform an inference on the input data and extract semantic information from the input data. Such extraction may occur when an uncertainty of a result of the inference is greater than or equal to a first threshold value. Further, the communication device (e.g., 350) of the edge device may transmit the semantic information to a server having a second artificial neural network. In this case, the semantic information includes data whose significance for the inference is greater than or equal to a threshold among the input data.

Thus, the novel collaborative inference method based on semantic communications developed by the inventors provides a substantive advancement in the aforementioned technological fields and a significant improvement in the collaborative inference frameworks, compared to conventional approaches.

In one or more aspects of the present disclosure, the second artificial neural network includes a second plurality of neuron circuits and a second plurality of synaptic circuits. A total number of the plurality of neuron circuits in the first artificial neural network is less than a total number of the second plurality of neuron circuits in the second artificial neural network, and/or a total number of the plurality of synaptic circuits in the first artificial neural network is less than a total number of the second plurality of synaptic circuits in the second artificial neural network.

Further, in one or more aspects, a size of the semantic information is less than a size of the input data. In an example, a size of the semantic information may represent a total amount of data in the semantic information, a total number of digital bits or bytes in the semantic information, or a total length of the semantic information. In an example, a size of the input data may represent a total amount of the input data, a total number of digital bits or bytes in the input data, or a total length of the input data.

In one or more aspects, an artificial neural network may include a machine learning model. A machine learning model may be a deep learning model described herein. A weak machine learning model may be or may represent a weak classifier. A strong machine learning model may be or may represent a strong classifier.

In one or more aspects, unlike a conventional approach, the technical features of the present disclosure can reliability bring forth advancements and improvements in the functioning of computers and the aforementioned technical fields by: performing an inference on input data using a machine learning model by an edge device; extracting semantic information from the input data; and transmitting the semantic information to a server, where the semantic information includes data whose significance for the inference is greater than or equal to a threshold among the input data.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A collaborative inference method based on semantic communications, the method comprising:
acquiring input data by an edge device;
performing an inference on the input data by using a machine learning model by the edge device;
computing an uncertainty of a result of the inference by the edge device;
extracting semantic information from the input data by the edge device when the uncertainty is greater than or equal to a threshold value; and
requesting a second inference by transmitting the semantic information to a server by the edge device,
wherein the semantic information comprises data whose significance for the inference is higher than or equal to a threshold among the input data.

2. The method of claim 1, wherein the semantic information comprises data whose attention score is greater than or equal to a second threshold value among the input data, and the attention score is determined by using an attention value computed in a process of performing the inference using the machine learning model.

3. The method of claim 1, wherein the edge device computes the uncertainty based on an entropy of the result of the inference.

4. The method of claim 1, wherein the machine learning model is a transformer-based model, and the semantic information comprises at least one patch selected from a plurality of patches based on attention scores of a plurality of tokens segmented from the input data.

5. The method of claim 1, wherein the machine learning model is a vision transformer model, and the semantic information comprises at least one patch selected from a plurality of patches based on attention scores of the plurality of patches segmented from the input data which is an image.

6. The method of claim 5, wherein the semantic information comprises:
a certain number of upper patches among the plurality of patches based on the attention scores of the plurality of patches;
patches whose attention scores are higher than or equal to a certain threshold value among the plurality of patches; or
patches selected from the plurality of patches based on a descending order of the attention scores of the plurality of patches, wherein the selected patches correspond to a maximum number of patches, where a sum of the attention scores of the selected patches are less than a certain threshold value.

7. A hardware device for performing collaborative inference based on semantic communications, the hardware device comprising:
an interface device for acquiring input data, which is a target to be inferred;
a storage device for storing a pre-trained weak machine learning model;
a computation device for performing an inference on the input data by using the pre-trained weak machine learning model and for extracting semantic information from the input data when an uncertainty of a result of the inference is greater than or equal to a first threshold value; and
a communication device for transmitting the semantic information to a server,
wherein the semantic information comprises data whose significance for the inference is greater than or equal to a threshold among the input data.

8. The hardware device of claim 7, wherein the communication device is configured to obtain, from the server, a result inferred by a strong machine learning model by using the semantic information.

9. The hardware device of claim 7, wherein the computation device is configured to compute the uncertainty based on an entropy of the result of the inference.

10. The hardware device of claim 7, wherein the pre-trained weak machine learning model is a transformer-based model, and the semantic information comprises at least one patch selected from a plurality of patches based on attention scores of a plurality of tokens segmented from the input data.

11. The hardware device of claim 7, wherein the pre-trained weak machine learning model is a vision transformer model, and the semantic information comprises at least one patch selected from a plurality of patches based on attention scores of the plurality of patches segmented from the input data which is an image.

12. The hardware device of claim 11, wherein the semantic information comprises:
a certain number of upper patches among the plurality of patches based on the attention scores of the plurality of patches;
patches whose attention scores are higher than or equal to a certain threshold value among the plurality of patches; or
patches selected from the plurality of patches based on a descending order of the attention scores of the plurality of patches, wherein the selected patches correspond to a maximum number of patches, where a sum of the attention scores of the selected patches are less than a certain threshold value.

13. The hardware device of claim 7, wherein a size of the semantic information is less than a size of the input data.

14. A hardware device for performing collaborative inference based on semantic communications, the hardware device comprising:
an artificial neural network; and
a communication device,
wherein the artificial neural network comprises:
a plurality of neuron circuits; and
a plurality of synaptic circuits,
wherein:
each of the plurality of synaptic circuits is provided between a respective neuron circuit and one or more neuron circuits;
each of the plurality of neuron circuits is configured to receive an input and apply a transformation based on a synaptic weight of a respective synaptic circuit;
at least some of the plurality of neuron circuits in the artificial neural network are configured to acquire input data;
the artificial neural network is configured to perform an inference on the input data and to extract semantic information from the input data when an uncertainty of a result of the inference is greater than or equal to a first threshold value;
the communication device is configured to transmit the semantic information to a server having a second artificial neural network, and
wherein the semantic information comprises data whose significance for the inference is greater than or equal to a threshold among the input data.

15. The hardware device of claim 14,
wherein the second artificial neural network comprises:
a second plurality of neuron circuits; and
a second plurality of synaptic circuits,
wherein:
a total number of the plurality of neuron circuits is less than a total number of the second plurality of neuron circuits; or
a total number of the plurality of synaptic circuits is less than a total number of the second plurality of synaptic circuits, and
wherein a size of the semantic information is less than a size of the input data.
